(19) United States
(12) Patent Application Publication
(10) Pub. No.: US 2018/0306488 A1
(43) Pub. Date: Oct. 25, 2018

(54) PROCESS FOR THE MANUFACTURE OF A SEALING GASKET FOR A REFRIGERATOR

(71) Applicant: CRISER, S.A. DE C.V., Guadalupe (MX)

(72) Inventors: Laura Beatriz ROVIRA-GARZA, Guadalupe (MX); Francisco BATES-HURTADO, Guadalupe (MX)

(73) Assignee: CRISER, S.A. DE C.V., Guadalupe (MX)

(21) Appl. No.: 15/642,920

(22) Filed: Jul. 6, 2017

(30) Foreign Application Priority Data
Apr. 19, 2017 (MX) MX/A/2017/005047

(51) Int. Cl. F25D 23/08; B29C 47/00; B29C 47/06; B29C 47/88; B23K 1/00

(52) U.S. Cl. CPC F25D 23/087; B29C 47/0066; B29C 47/06; B29L 2031/265; B23K 1/0008; B29K 2995/0008; B29C 47/8815

(57) ABSTRACT

The present invention relates to a process for the manufacture of a sealing gasket for a refrigerator, which simultaneously uses at least three extruders to form in a single operation a sealing gasket. The extruders simultaneously feed, in an extrusion die, a rigid or semi-rigid polymer, a flexible polymer and a mixture of a binder polymer and a magnetic material, for simultaneously forming the sealing gasket and, wherein a magnetizable zone is fully embedded within the gasket. After the sealing gasket has been formed in the extrusion die, it is cooled in a cooling section and then passed to a magnetization step to cause permanent magnetic fields and to ensure that the sealing gasket is fully magnetized.

### FIELD OF THE INVENTION

The present invention relates to sealing gaskets for refrigeration and, more specifically, to a process for the manufacture of a sealing gasket for a refrigerator.

### BACKGROUND OF THE INVENTION

The refrigerator is one of the most common appliances in the world. A refrigerator is a device mainly used in the kitchen, with a main compartment in which a temperature of between 2 and 6° C. is maintained, and also frequently an extra compartment used for freezing at −18° C. and properly called, freezer.

The fundamental reason for having a refrigerator is to keep food cold. Cold temperatures help keep food fresh longer. The basic idea behind refrigeration is to slow down the activity of bacteria (which all food contains) so that it takes longer for the bacteria to spoil the food.

However, proper operation of a refrigerator depends on many factors such as the external environment, lack of refrigerant, temperature regulation, hot air entering the refrigerator through the gasket, etc. There are currently a number of developments for gasket and door seal seals of a refrigerator, such as for example that described in U.S. Pat. No. 3,077,644 to Keith Kesling, which relates to a refrigerator door gasket for a refrigerator cabinet having a pair of doors, which includes sealing strips containing magnetic particles which are contained in the inner part of the plastic gaskets. These magnetic strips are adapted to cooperate with the refrigerator's metal cabinet when the door is closed, providing a good seal between the door and cabinet.

However, this type of gasket has the disadvantage that when the plastic sealing gasket is hardened, it decreases the sealing capacity and allows the entry of hot air into the refrigerator.

Another disadvantage of this type of packaging is that when the gasket is hardened, sometimes it is broken by exposing the magnetic tape, which tends to slide or detach from the package, thereby avoiding a good seal.

Other type of gasket for refrigerator is shown in U.S. Pat. No. 4,617,759 assigned to Bruno Pasqualine et al., which relates to a profile of plastic material for refrigerator and similar cabinets, comprising a bellows gasket portion which provides a seal between the door and the cabinet, characterized in that the profile and the gasket portion are integral and form only one piece produced by co-extrusion of two materials having a different rigidity such as to permit a ready detachment of the gasket portion, which is less rigid than the profile, from the profile along the region of their connection, under an appropriate manual or mechanical force, and that the said profile has on its side facing the cabinet a pair of lateral faces between which a groove is defined, suitable for receiving a substituting bellows gasket portion, and on its side facing the door at least one side-flange elastically yielding, acting as a spring for press (snap); coupling the door and the counterdoor in cooperation with the said lateral faces, each one of the said faces operatively self-positioning relatively to the door shell and the counterdoor.

The U.S. Pat. No. 4,469,383 assigned to Gerhard Losert, relates to a refrigerator and freezers cabinets and their method of construction and is more particularly concerned with a cabinet including an improved magnetic gasket construction for preventing sweating of the cabinet door in the vicinity of the sealing gasket and provides easy assembly of the door.

U.S. Pat. No. 5,309,680 assigned to Lowell Kiel relates to a magnetic seal for releasably sealing two doors arranged side by side on a thermally insulated cabinet such as a refrigerator or freezer. A retainer gasket is affixed to the inner edge of each door. One of the retainer gasket encloses a magnet and retains the magnet fixed in place relative to the door. Another retainer gasket is affixed to the other door and is formed of a base, a sleeve enclosing a second magnet, and two flexible webs connecting the sleeve to the base. The retainer gaskets and magnets are arranged so that the magnets impart an attractive force on each other and releasably seal the doors. When one of the doors is opened slightly, the magnets are arranged to repel each other and assist in easily opening at least one of the doors. Finally, a magnet having more than two magnetic poles may be used to assist in sealing and opening at least one of the doors.

Finally, U.S. Pat. No. 6,266,970, a vertical partition cover assembly of a side-by-side type refrigerator includes a cover coupled to the front of a vertical partition and a fixing member for fixing a hot tube to the inside of the cover. The cover includes a sealing surface to closely contact gaskets and a mechanism which holds the sealing surface to the front of the vertical partition. In one embodiment, the mechanism includes connecting portions extending inward from both ends of the sealing surface, and a pair of pocket portions formed at each end of the connecting portions to hold the front ends of liners forming the vertical partition. The fixing member includes a concave portion for holding the hot tube tightly in contact with the sealing surface, and a pair of elastic portions extending to the inside of the vertical partition from both ends of the concave portion to be fitted elastically to the inner ends of the respective pocket portions.

However, as can be seen from the cited patents, in all cases the sealing gaskets use a flexible magnetic strip which, as described above, tends to detach from the plastic packaging or does not properly seal the door with the cabinet of the refrigerator.

In order to avoid the use of a magnetic strip in the sealing gaskets of the refrigerators, magnetic gaskets for the door of a refrigerator, such as that described in Utility Model No. MX3197 which includes at least one surface of magnetic nanoparticles fully embedded in the gasket, said surface contacting a cabinet of a refrigerator at the time of door is closed.

The type of magnetic nanoparticles used is, for example, hexagonal ferrites which have multiple commercial applications: magnetic recording materials, permanent magnets, applications in microwave devices, ferrofluids and more. The ferrites that crystallize with the spinel-like structure (AFe₂O₄, A=Fe, Mn, Ni, Cu, Co, etc.) can be considered as one of the most important magnetic materials. These materials are used in numerous magnetic and electronic devices because of their high magnetic permeability and low losses. In addition, ferrites in the form of nanoparticles (nanoferrites) because they present different magnetic properties to the bulk material are being used in another series of applications such as magneto-optics, ferrofluids, spintronics, biomedical applications.

However, the traditional manufacturing system for this type of sealing gasket requires two types of processes. In a first process of operation a rigid polymer and a flexible polymer are extruded to form the sealing gasket and, in a second operation, separated from the first, a magnetic material or strip is processed.

Normally an extrusion line for a profile consists of an extruder with a barrel and spindle design suitable for the type of material to be processed. At the end of the extruder, a die will conform the polymer in a plastic state to the required profile dimensions. However, in order to ensure the accuracy of product dimensions, it is necessary to install a forming or calibration unit, in which the tube or profile will acquire the dimensions that ensure the subsequent joints or welds made with them.

Once the dimensions of the product have been reached, it passes through a cooling zone where the excess heat is removed, avoiding any subsequent deformation of the product. Finally, depending on the flexibility of the product, a cutting or winding unit prepares the product for storage.

On the other hand, a magnetizable strip is manufactured in an independent extrusion process and after is introduced into a cavity that is formed in the first profile to continue with the following process steps. In this case the magnetizable strip of a mixture of a binding polymer and a magnetic material are extruded into a mold and then passed into a cooling step. Once the product has cooled, the magnetizable strip is subjected to a magnetizing step to cause permanent magnetic fields in the sealing gasket, to finally be stored as a finished product.

And finally, a third operation is carried out in which the two components are integrated for assembly and reinforcement of the door seal.

In this case, the magnetizable strip is unwound and is guided to a cut section to cut it in predefined sections, to store them in a storage section or hopper.

From that step, the formed profile of the rigid polymer and flexible polymer and the magnetizable strip are integrally joined in an assembler for forming the sealing gasket.

Finally, once both parts are assembled, the sections are welded together to form a frame, that is, a frame spice that will be installed in the door or between the surfaces between which the sealing is desired.

As can be seen from the foregoing, the prior art process is complex since two production lines are required for forming the sealing gasket. In a first production line the packaging profile is formed and, in a second production line the magnetizable strip is manufactured to finally to join together in a third stage of operation.

Accordingly, the present invention relates to a process for the manufacture of a sealing gasket for a refrigerator, which simultaneously uses three extruders to form in a single operation a sealing gasket. The three extruders simultaneously feed an extrusion die with a rigid polymer, a flexible polymer, and a compound of a binder polymer and a magnetic material for forming the gasket and wherein the magnetizable strip is completely embedded from the origin in the sealing gasket.

### OBJECTIVES OF THE INVENTION

It is therefore a first objective of the present invention to provide a process for the manufacture of a sealing gasket for a refrigerator, which facilitates the manufacture thereof.

It is another objective of the present invention to provide a process for the manufacture of a sealing gasket for a refrigerator, which reduces the production lines, making in a single step the formation of the gasket by means of the simultaneous extrusion of three materials, to give it the form required to the sealing gasket.

A further objective of the present invention to provide a process for the manufacture of a sealing gasket which includes a zone or the entire body of the gasket embedded with magnetic nanoparticles.

It is a further objective of the present invention to provide a process for the manufacture of a sealing gasket which realizes the formation of a sealing gasket in a single operation with very little material waste.

### BRIEF DESCRIPTION OF THE DRAWINGS

These and other objectives and advantages of the present invention will be more clearly understood from the following detailed description together with the accompanying flowcharts, wherein:

FIG. 1 is a schematic diagram of a first process embodiment for the manufacture a sealing gasket, in accordance with the present invention; and,

FIG. 2 is a schematic diagram of a second embodiment of the process for the manufacture of a sealing gasket, in accordance with the present invention.

### DETAILED DESCRIPTION OF THE INVENTION

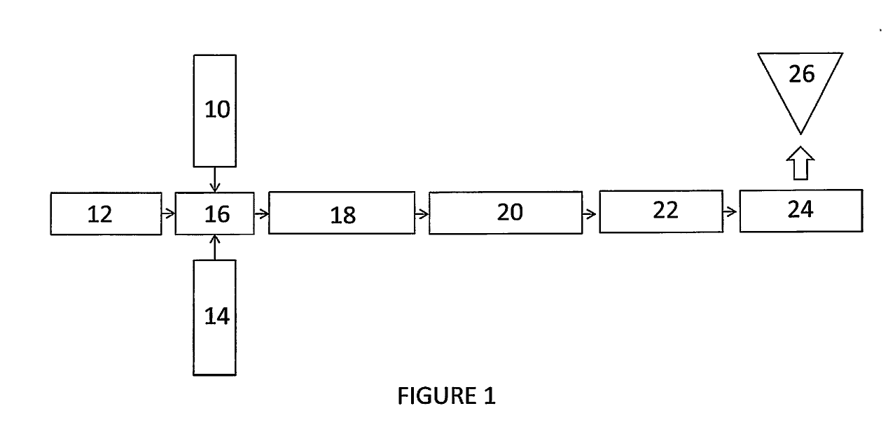

Making now reference particular to FIG. 1, there is shown in schematic flowchart a first embodiment of the manufacturing process of a sealing gasket which comprises: three extruders 10, 12, 14, which are coupled in coincidence with an extrusion die 16, having the desired shape of the sealing gasket.

As is known in the art, in an extrusion process, a polymer material from a hopper is fed in solid form into de barrel of the extruder. The material is gradually melted and is then forced into a die, which shapes the polymer with a pre-set geometric profile. According to the process of the present invention, a first extruder 10 melts and feeds a rigid or semi-rigid polymer material for forming a rigid or semi-rigid zone in the sealing gasket. That is, the sealing gasket may be formed of two flexible materials or of different hardness. This rigid or semi-rigid zone is usually attached to or attached to the cabinet of a refrigerator (not shown). Said rigid zone being formed of polypropylene, rigid PVC, polyethylene, ABS (acrylonitrile butadiene styrene), HIPS (high impact polystyrene), PA (polyamide) or a mixture thereof.

The second extruder 12 feeds and melts a flexible polymer material for forming a flexible zone in the sealing gasket. This flexible zone normally contacts the refrigerator door (not shown) when the door is closed, providing a seal between the door and cabinet. Said rigid zone being formed of flexible PVC, EVA (ethylene-vinyl acetate or ethylene vinyl acetate), TPV (thermoplastic vulcanized), TPU (thermoplastic polyurethane), TPE (thermoplastic elastomers), polyethylene or mixtures thereof.

Finally, the third extruder 14 feeds and melts a mixture of a binder material such as: EVA (ethylene-vinyl acetate or ethylene vinyl acetate), PVC, chlorinated polyethylene, TPU (thermoplastic polyurethane), TPV (thermoplastic vulcanizate) and a magnetic material such as: strontium ferrite or barium ferrite, forming an area of a magnetizable material. Strontium ferrite or barium ferrite can be in the form of micrometric particles whose diameter is between 100 and 2500 nanomethers or nanometric particles (nanoparticles) whose diameter is between 1 and 100 nanometers.

All of these materials are simultaneously extruded by means of the first extruder 10, second extruder 12, and third extruder 14 which are coupled with the extrusion die 16, for simultaneously forming the sealing gasket in a continuous strip including the rigid or semi-rigid zone and the flexible zone. During this operation the magnetizable section is completely embedded or in sections pre-established with the flexible zone.

The extrusion die 16 is designed to receive the flows of the three materials in a stable form, and direct it into the cavities necessary to give the desired shape to the product (sealing gasket). The flow of the three materials is pushed by the three extruders 10, 12, 14, at the beginning of the extrusion line.

Once the newly formed gasket has been formed in the extrusion die 16, the product has acquired its final shape and requires cooling. At this stage, the sealing gasket passes to a cooler 18 where it is cooled with water, in a temperature range of 10 to 15 degrees Celsius. At this stage the sealing gasket already has its final shape and when cooled it maintains its definitive dimensions. After the cooling step, air is additionally used to dry the product and prevent the water from being passed to the next process steps.

Once the package has cooled, it goes into a magnetization step. In this case, the sealing gasket is passed through a magnetizing machine 20 to cause permanent magnetic fields and to ensure that the sealing gasket is fully magnetized.

The gasket is pulled by a pulling machine (not shown), which is located after the magnetizing machine 20 pulling the product being formed in the extrusion die 16, applying a constant tension or pull to the product to maintain it moving. The speed of the pulling machine is controlled because a higher drag speed affects the dimensions and quality of the product.

Thereafter, the sealing gasket is cut in sections by means of a disc cutter 22 according to predetermined dimensions and with an angle of 45° at its ends and, for the preparation of the product to the next production step. The cutting machine 22 has a controller which is monitoring the progress of the sealing gasket and determines the time to perform the cutting process on an programmed length. At the start of the cutting process, the advance of the sealing gasket is stopped and two cutting blades (not shown) are advanced to make the cut and after the cut said cutting blades are retracted again, restarting the magnetic seal advance.

Once the cuts of the sealing gasket (not shown) are made according to the preset dimensions, the cut sections are welded in a welding machine 24 to assemble a structure or frame to be installed in the cooling door or in those surfaces that requires be sealed with a sealing gasket.

Finally, the finished product is stored or packed (warehouse 26) for delivery.

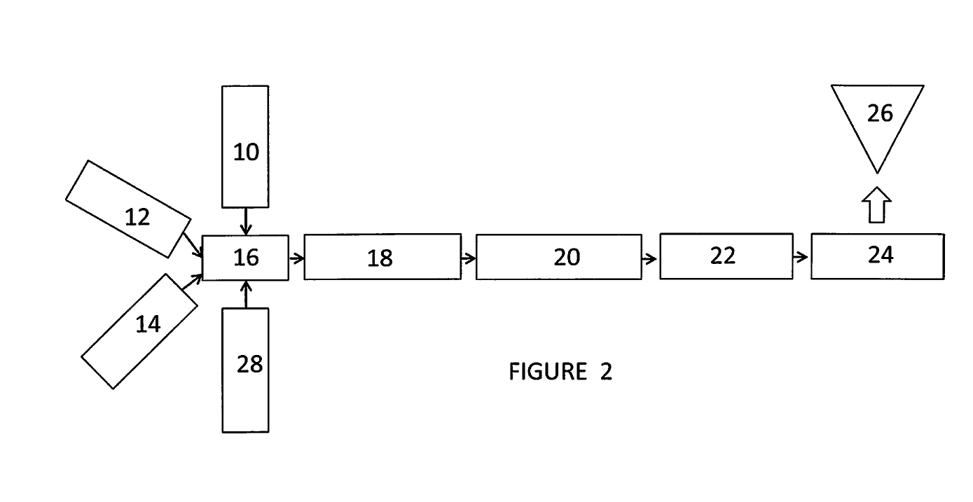

In a second embodiment of the present invention (FIG. 2), the sealing gasket manufacturing process may utilize four or more extruders. That is, there may be included a fourth extruder 28 which extrudes a rigid polymer material as described above or semi-rigid polymeric materials, for example a plasticized (semi-rigid and flexible) PVC, polyethylene, or polypropylene mixed with a pigment such as iron oxide, chromium oxide, either to form a rigid section or a semi-rigid section of color or a section with a flexible color polymer material.

From the foregoing, although two embodiments of a manufacturing process for refrigerator sealing gasket have been described, it will be apparent to those skilled in the art that other possible advances or modifications may be made, which may be considered within the given field by the following claims.

We claim:

1. A process for the manufacture of a sealing gasket for a refrigerator comprising:
Providing an extrusion die for forming a sealing gasket;
Providing a first extruder for feeding a rigid or semi-rigid polymer material for forming a rigid or semi-rigid zone in the sealing gasket;
Providing a second extruder for feeding a flexible polymer material for forming a flexible zone in the sealing gasket;
Providing a third extruder for feeding a mixture of a binder material and a magnetic material to provide a magnetizable zone to the sealing gasket;
Coupling the first extruder, second extruder and third extruder with the extrusion die;
Extruding simultaneously the rigid polymer material, the flexible polymer material and the mixture of the binder material and magnetic material into the extrusion die for simultaneously forming the sealing gasket in a continuous strip including the rigid zone and the flexible zone, said magnetizable zone remaining fully embedded or in predefined sections in the flexible zone;
Cooling the sealing gasket in a cooling section after it has been formed in the extrusion die;
Passing the gasket to a magnetization step to provoke permanent magnetic fields and ensure that the gasket is fully magnetized; and,
Cutting the magnetized sealing gasket into sections of pre-established lengths.

2. The process as claimed in claim 1, wherein the rigid polymer material is polypropylene, rigid PVC, polyethylene, ABS (acrylonitrile butadiene styrene), HIPS (high impact polystyrene), PA (polyamide) or a mixture thereof.

3. The process as claimed in claim 1, wherein the flexible polymeric material is flexible PVC, EVA (ethylene-vinyl acetate or ethylene vinyl acetate), TPV (thermoplastic vulcanized), TPU (thermoplastic polyurethane), TPE (thermoplastic elastomers), polyethylene or mixtures thereof.

4. The process as claimed in claim 1, wherein the binder material is: EVA (ethylene-vinyl acetate or ethylene vinyl acetate), PVC, chlorinated polyethylene, TPU (thermoplastic polyurethane), TPV (thermoplastic vulcanizate) or TPE (thermoplastic elastomers).

5. The process as claimed in claim 1, wherein the magnetic material is strontium ferrite or barium ferrite.

6. The process as claimed in claim 1, wherein the cooling step is carried out in a cooling tub in a temperature range of between 10 to 15° Celsius.

7. The process as claimed in claim 1, including the step of: soldering portions of magnetized sealing gaskets to assemble a structure or frame to be installed in the cooling door or in those surfaces that requires be sealed with a sealing gasket.

8. The process as claimed in claim 1, wherein the magnetic material is in the form of micrometric particles with a diameter between 100 and 2500 nanometers.

9. The process as claimed in claim 1, wherein the magnetic material is in the form of nanometric particles with a diameter between 1 and 100 nanometers.

10. The process as claimed in claim 1, further comprising, providing a fourth extruder for extruding a rigid polymer material or a semi-rigid polymer material mixed with a pigment, to form a section rigid section or a semi-rigid section of color or a section with a flexible color polymer material.

11. The process as claimed in claim 10, wherein the semi-rigid material is plasticized PVC, polyethylene or polypropylene.

12. The process as claimed in claim 10, wherein the pigment is iron oxide or chromium oxide.
